(19) United States
(12) Patent Application Publication
(10) Pub. No.: US 2003/0055746 A1
(43) Pub. Date: Mar. 20, 2003

(54) Method and system for generating configuration data

(76) Inventor: Alan Bishop, Calgary (CA)

Correspondence Address: PERKINS COIE LLP, PATENT-SEA, P.O. BOX 1247, SEATTLE, WA, 98111-1247, US

(21) Appl. No.: 09/899,826

(22) Filed: Jul. 5, 2001

(51) Int. Cl. G06F 17/60

(52) U.S. Cl. 705/27

(57) ABSTRACT

A method and system for generating a set of configured applications for a device with a specified hardware configuration. The configuration system receives an indication of the applications that are to be supplied with the device and receives an indication of the hardware configuration of that device. The applications are to execute in the hardware environment specified by the hardware configuration of the device. Initially, the configuration system generates binary code for each of the applications. The configuration system then retrieves a configuration definition for each of the applications. The configuration system then generates configuration data in accordance with the configuration definitions and the specified hardware environment. The configuration system then combines the generated binary code and the generated configuration data to form a set of configured applications.

### TECHNICAL FIELD

The described technology relates generally to generating configuration data and particularly to generating configuration data for applications based on a specified hardware environment.

### BACKGROUND

Current techniques for generating configuration data for applications that are to execute in a certain hardware environment are both time-consuming and expensive. To meet the needs of their customers, companies may provide devices whose hardware and software can be customized to the needs of their customers. For example, devices have been developed for electrical utilities to assist in substation control, monitoring, and measurement. One such device may include functions that were previously provided by many different discrete devices. The functions of a single device may include power quality monitoring, digital fault recording, and substation metering. Power quality information may include total harmonic distortion, harmonic spectrum (DC to 21st harmonic), RMS trending, RMS profiling, voltage sags, swells, and interruptions. Digital fault recording information may be collected and automatically transferred via a LAN to a substation computer or via electronic mail to a user's computer. To detect faults, the device captures analog channels and digital channels of information simultaneously and provides configurable triggers and detriggers. The substation metering may allow for 1, 2, 2½, and 3-element metering for various feeders on the same bus in a 3-wire or 4-wire configuration.

Because these devices provide many different functions and allow many different hardware configurations, the generating of the configuration data for the applications that run on the devices is a very complex process. Traditionally, a customer would provide their order to the company via facsimile or electronic mail. The order would specify a combination of functions (e.g., applications) and a hardware configuration. A company representative would then review the order to ensure that it was complete and that the combination of functions and the hardware configuration were consistent. If not, then the company representative would contact the customer to resolve any inconsistencies. The company would then assign an engineer to generate the applications that implement the ordered functions with the appropriate configuration data for the ordered device. The process of generating the applications may involve compiling and linking various software modules. The process of generating the configuration data may involve painstakingly creating configuration tables for each application that takes into consideration the hardware configuration of the device. For example, one application may need configuration data that specifies the number of input and output devices, the types of devices (e.g., analog input), the communications ports, and so on in one format, and another application may need the same configuration data, but in a different format, along with additional configuration data. Once the applications and the configuration data are generated, then the engineer can load the applications configured with the configured data on a device with a specified hardware configuration. If the engineer discovers a problem, then the engineer performs diagnostics to identify the source of the problem, which often results from improperly generated configuration data.

It would be desirable to have a technique that would allow for the automatic generation of configuration data based on the applications and hardware configuration selected by a customer.

### BRIEF DESCRIPTION OF THE DRAWINGS

FIG. 1 is a diagram illustrating a display page for entry of an order. In the illustrated embodiment, an order entry system is implemented as a web server.

FIG. 2 is a flow diagram illustrating the overall processing of the configuration system in one embodiment.

FIG. 3 is a block diagram illustrating the components of the configuration system in one embodiment.

FIG. 4 is a flow diagram illustrating the processing of the request submitter component in one embodiment.

FIG. 5 is a flow diagram illustrating the processing of the configuration request manager component in one embodiment.

FIG. 6 is a flow diagram illustrating the processing of the generate function of the firmware generate component in one embodiment.

FIG. 7 is a flow diagram illustrating the processing of the generate function of the configuration generator component in one embodiment.

FIG. 8 is a flow diagram illustrating the processing of the configure application component in one embodiment.

FIG. 9 is a flow diagram illustrating the processing of the process table component in one embodiment.

FIG. 10 is a flow diagram illustrating the processing of the process record component in one embodiment.

FIG. 11 is a flow diagram illustrating the processing of the process script rules component in one embodiment.

FIG. 12 is a flow diagram illustrating the processing of the process script function component in one embodiment.

FIG. 13 is a flow diagram illustrating the processing of the process table cells component in one embodiment.

FIG. 14 is a flow diagram illustrating the processing of the process cell calculation link component in one embodiment.

FIG. 15 is a flow diagram illustrating the processing of the process cell calculation link component in one embodiment.

FIG. 16 is a flow diagram illustrating the processing of the process cell bit field list component in one embodiment.

FIG. 17 is a flow diagram illustrating the processing of the cell multiple entry list component in one embodiment.

### DETAILED DESCRIPTION

A method and system for generating a set of configured applications for a device with a specified hardware configuration is provided. In one embodiment, the configuration system receives an indication of the applications that are to be supplied with the device and receives an indication of the hardware configuration of that device. The applications are to execute in the hardware environment specified by the hardware configuration of the device. Initially, the configuration system generates binary code for each of the applications. The configuration system then retrieves a configuration definition for each of the applications. The configuration definition for an application defines configuration data for the application in different hardware environments. The configuration system then generates configuration data in accordance with the configuration definitions and the specified hardware environment. The configuration system then combines the generated binary code and the generated configuration data to form a set of configured applications. A configuration definition may include table definitions that specify the contents of various configuration tables for an application. A table definition specifies the contents of the rows of a configuration table. Each row of a configuration table contains cells with configuration data. The configuration definition may specify that the content of each cell is data included in the table definition, data returned when a script (e.g., a BASIC program) is executed, data returned when a function stored in a library of compiled functions is executed, data retrieved from a properties file, and so on. In this way, configuration data for applications can be automatically generated when an order is placed for those applications within a specified hardware environment.

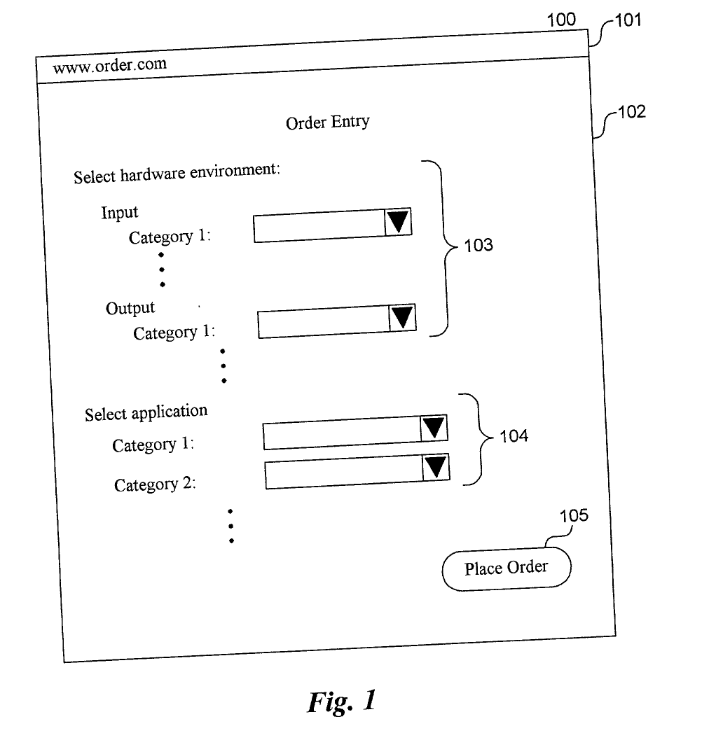

FIG. 1 is a diagram illustrating a display page for entry of an order. In the illustrated embodiment, an order entry system is implemented as a web server. The order entry system provides web pages through which a customer of a company can identify themselves and place an order for a device provided by the company. Display page 100 includes an address area 101 and an order entry area 102. The address area contains a URL that identifies the order entry display page. The order entry area includes a hardware environment entry area 103 and an application entry area 104. The customer uses the hardware environment entry area to select the hardware environment to be included on the device. For example, if the device is for monitoring a substation of an electrical utility, then the hardware configuration may indicate the number of analog and digital inputs. The customer uses the application entry area to select the applications that are to be included with the device. The entry areas may include drop-down lists, radio buttons, and so on for selection of various options. The order entry system ensures that a customer will select a consistent hardware environment and set of applications. When the customer has completed selecting the hardware environment and applications, the customer selects the place order button 105 to submit the order.

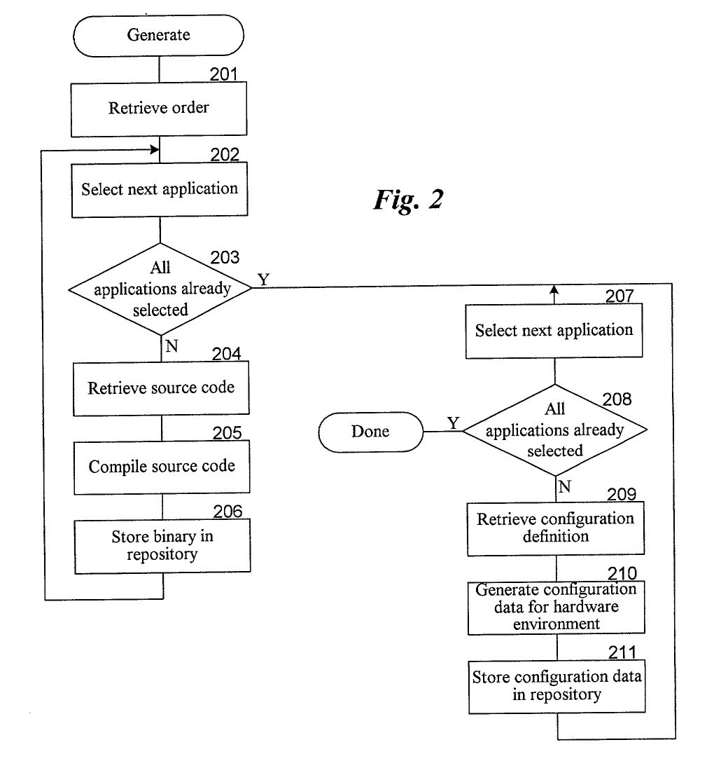

After the order is submitted, it is stored in an order database and then prepared for processing by the configuration system. The configuration system is then started to process the prepared order. FIG. 2 is a flow diagram illustrating the overall processing of the configuration system in one embodiment. The configuration system is provided with the prepared order. The configuration system first compiles the source code for the applications into binary code and then generates the configuration data for the applications. The binary code for the applications may be stored in a nonvolatile memory of the device, followed by the configuration data for the applications. In block 201, the configuration system retrieves an order from an order database. The order entry system of the web server may store its order information in the order database. Each retrieved order may have an order identifier that uniquely identifies the order. In blocks 202-206, the configuration system loops, generating the binary code for each of the selected applications. In block 202, the configuration system selects the next application of the retrieved order. In decision block 203, if all the applications of the retrieved order have already been selected, then the configuration system continues at block 207, else the configuration system continues at block 204. In block 204, the configuration system retrieves the source code for the selected application. The application may be specified by name and a version number. In addition, the configuration system may retrieve different versions of the source code depending on the hardware environment specified by the customer. In block 205, the configuration system compiles the retrieved source code into binary code. Alternatively, the source code may be precompiled and the configuration system need only retrieve the binary code, rather than compiling the source code each time an order is processed. In block 206, the configuration system stores the binary code in a configuration repository in association with the order identifier and then loops to block 202 to select the next application. In blocks 207-211, the configuration system loops, generating configuration data for each application of the retrieved order. In block 207, the configuration system selects the next application of the retrieved order. In decision block 208, if all the applications of the retrieved order have already been selected, then the configuration system has completed generating the configured applications, else the configuration system continues at block 209. In block 209, the configuration system retrieves the configuration definition for the selected application. In block 210, the configuration system generates the configuration data from the retrieved configuration definition for the selected hardware environment. In block 211, the configuration system stores the configuration data in the configuration repository in association with the order identifier, and then loops to block 207 to select the next application.

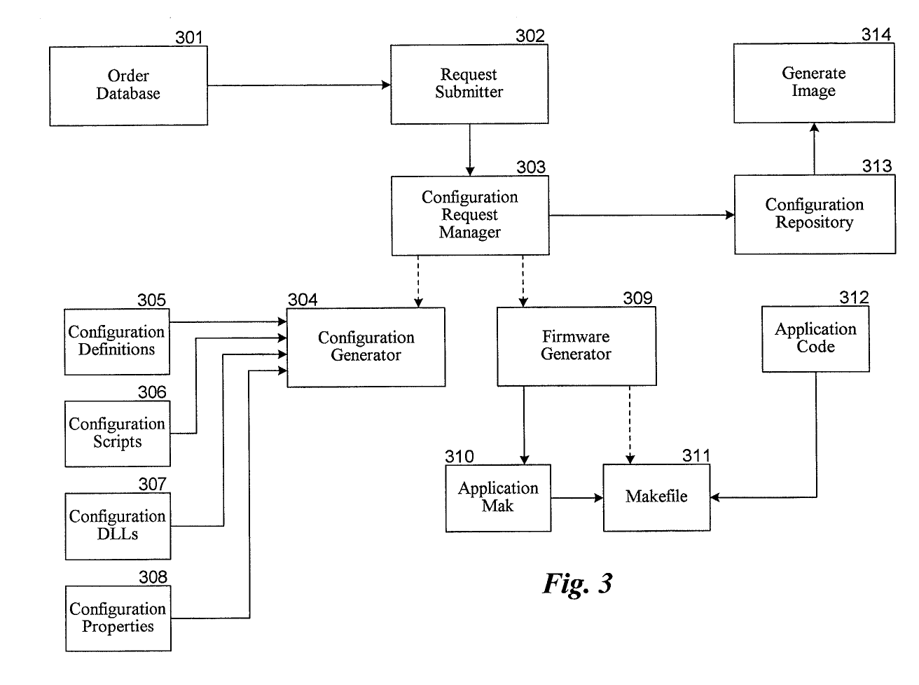

FIG. 3 is a block diagram illustrating the components of the configuration system in one embodiment. The components of the configuration system include a request submitter 302, a configuration request manager 303, a configuration generator 304, and a firmware generator 309. The request submitter retrieves orders from the order database 301 that are ready to be processed, prepares the order for processing, and invokes the configuration request manager to generate the configured applications for the order. The configuration request manager invokes the firmware generator to generate the binary code for each application and invokes the configuration generator to generate the configuration data for each application. The configuration request manager then stores the binary code and configuration data in the configuration repository 313. The firmware generator creates an application makefile 310 for controlling the compiling of the applications. The application makefile may contain an entry for each application that controls the compilation process of that application. The firmware generator then invokes a standard makefile component 311 to generate the binary code. The makefile component inputs the application makefile and retrieves the application source code from the application code database 312. The firmware generator compiles the source code and returns binary code to the configuration request manager for storage in the configuration repository. The configuration generator generates the configuration data for an application program. The configuration generator retrieves the configuration definition of each application from the configuration definition database 305. The configuration generator then generates the configuration data in accordance with the configuration definitions. The configuration definition may reference the configuration script file 306, the configuration DLL file 307, and the configuration properties file 308. The configuration script file may contain the scripts or BASIC programs that return values for cells of a configuration table. The configuration DLL file may contain dynamic link libraries with functions that return values for cells of a configuration table. The configuration properties may contain name and value pairs of properties for the cells of a configuration table.

The configuration system may execute on a computer system that includes a main memory, a central processing unit, input devices (e.g., keyboard input devices), output devices (e.g., display devices), and storage devices, such as a hard drive, a CD-ROM, or a floppy disk drive. The main memory and storage devices are computer-readable media that may contain instructions for implementing the configuration system. Also, one skilled in the art will appreciate that various communication channels such as the Internet, a wide area network, or point-to-point, dial-up connections can be used to interconnect the configuration system, the web server, and the customer computers.

Table 1 contains a portion of an XML schema for configuration definitions in one embodiment. The schema specifies that a configuration definition is formed by a hierarchy of elements with an application element (lines 105-108) as its root element. An application element includes a tables element and optionally a script rules element. A tables element specifies the content of the configuration tables, and the script rules element that is directly below the application element in the hierarchy defines scripts that may be referenced by the tables element. A tables element (lines 102-104) includes zero or more table elements. A table element (lines 91-101) includes various attributes, and may include a script rules element and a table cells element. The attributes of a table element include a table number of records attribute that specifies the number of records in a table. The table cells element (lines 88-90) may include a table cell element for cells in a record of the table. A table cell element (lines 69-87) contains attributes relating to the cell and may include a cell property link element, a cell calculation link element, a table element, a cell bit field list element, a cell multiple entry list element, and a script rules element. The cell multiple entry list element (lines 66-68) contains one or more multiple entry field elements. A multiple entry field element (lines 50-62) contains attributes that define a dynamic data type that is similar to a “c” union. The cell bit field list element list (lines 63-65) contains one or more bit field elements. A bit field element (lines 38-49) defines a binary value. The binary values of bit field elements are combined into bytes, as indicated by a cell bit field list element. A cell calculation link element (lines 34-37) contains attributes that specify the name of a DLL and the name of a function within the DLL. The cell property link element (lines 27-33) has attributes that reference a name and value pair in a properties file. The script rules element (lines 24-26) contains zero or more script rule elements. A script rule element (lines 20-23) contains zero or more script functions elements. A script function element (lines 12-16) contains a return type attribute and zero or more script parameters elements. A script parameters element (lines 9-11) contains zero or more script parameter elements. The script parameter element (lines 1-8) contains attributes specifying the parameters of a script function.

TABLE 1

| | |
|---|---|
| 1. | <ElementType name=“ScriptParameter”> |

| | |
|---|---|
| 2. | <attribute type=“ScriptParameterName”/> |
| 3. | <attribute type=“ScriptParameterDataType”/> |
| 4. | <attribute type=“ScriptParameterType”/> |
| 5. | <attribute type=“ScriptParameterRecordSetName”/> |
| 6. | <attribute type=“ScriptParameterFieldName”/> |
| 7. | <attribute type=“ScriptParameterCalculationName”/> |

| | |
|---|---|
| 8. | </ElementType> |
| 9. | <ElementType name=“ScriptParameters”> |

| | |
|---|---|
| 10. | <element type=“ScriptParameter” minOccurs=“0” |
| | maxOccurs=“*”/> |

| | |
|---|---|
| 11. | </ElementType> |
| 12. | <ElementType name=“ScriptFunction”> |

| | |
|---|---|
| 13. | <attribute type=“ScriptFunctionName”/> |
| 14. | <attribute type=“ScriptFunctionReturnType”/> |
| 15. | <element type=“ScriptParameters” minOccurs=“0” |
| | maxOccurs=“1”/> |

| | |
|---|---|
| 16. | </ElementType> |
| 17. | <ElementType name=“ScriptFunctions”> |

| | |
|---|---|
| 18. | <element type=“ScriptFunction” minOccurs=“0” |
| | maxOccurs=“*”/> |

| | |
|---|---|
| 19. | </ElementType> |
| 20. | <ElementType name=“ScriptRule”> |

| | |
|---|---|
| 21. | <attribute type=“ScriptRuleName”/> |
| 22. | <element type=“ScriptFunctions” minOccurs=“0” |
| | maxOccurs=“1”/> |

| | |
|---|---|
| 23. | </ElementType> |
| 24. | <ElementType name=“ScriptRules”> |

| | |
|---|---|
| 25. | <element type=“ScriptRule” minOccurs=“0” |
| | maxOccurs=“*”/> |

| | |
|---|---|
| 26. | </ElementType> |
| 27. | <ElementType name=“CellPropertyLink”> |

| | |
|---|---|
| 28. | <attribute type=“PropertyGUID”/> |
| 29. | <attribute type=“PropertyNameSpace”/> |
| 30. | <attribute type=“PropertyCategory”/> |
| 31. | <attribute type=“PropertyName”/> |
| 32. | <attribute type=“PropertyStandardTransformation”/> |

| | |
|---|---|
| 33. | </ElementType> |
| 34. | <ElementType name=“CellCalculationLink”> |

| | |
|---|---|
| 35. | <attribute type=“CalculationDll”/> |
| 36. | <attribute type=“CalculationMethod”/> |

| | |
|---|---|
| 37. | </ElementType> |
| 38. | <ElementType name=“BitField”> |

| | |
|---|---|
| 39. | <attribute type=“CellName”/> |
| 40. | <attribute type=“CellShortName”/> |
| 41. | <attribute type=“CellDescription”/> |
| 42. | <attribute type=“CellDefaultValue”/> |
| 43. | <attribute type=“CellMin”/> |
| 44. | <attribute type=“CellMax”/> |
| 45. | <attribute type=“CellRecommendedMin”/> |
| 46. | <attribute type=“CellRecommendedMax”/> |
| 47. | <attribute type=“CellList”/> |
| 48. | <attribute type=“CellUnitOfMeasure”/> |

| | |
|---|---|
| 49. | </ElementType> |
| 50. | <ElementType name=“MultipleEntryField”> |

| | |
|---|---|
| 51. | <attribute type=“CellName”/> |
| 52. | <attribute type=“CellArrayLength”/> |
| 53. | <attribute type=“CellDefaultValue”/> |
| 54. | <attribute type=“CellMin”/> |
| 55. | <attribute type=“CellMax”/> |
| 56. | <attribute type=“CellRecommendedMin”/> |
| 57. | <attribute type=“CellRecommendedMax”/> |
| 58. | <attribute type=“CellList”/> |
| 59. | <attribute type=“CellUnitOfMeasure”/> |
| 60. | <attribute type=“CellAssociatedItem”> |
| 61. | </attribute> |

| | |
|---|---|
| 62. | </ElementType> |
| 63. | <ElementType name=“CellBitFieldList”> |

| | |
|---|---|
| 64. | <element type=“BitField” minOccurs=“1” maxOccurs=“*”/> |

| | |
|---|---|
| 65. | </ElementType> |
| 66. | <ElementType name=“CellMultipleEntryList”> |

| | |
|---|---|
| 67. | <element type=“MultipleEntryField” minOccurs=“1” |
| | maxOccurs=“*”/> |

| | |
|---|---|
| 68. | </ElementType> |
| 69. | <ElementType name=“TableCell”> |

| | |
|---|---|
| 70. | <attribute type=“CellType”/> |
| 71. | <attribute type=“CellName”/> |
| 72. | <attribute type=“CellArrayLength”/> |
| 73. | <attribute type=“CellDefaultValue”/> |
| 74. | <attribute type=“CellMin”/> |
| 75. | <attribute type=“CellMax”/> |
| 76. | <attribute type=“CellRecommendedMin”/> |
| 77. | <attribute type=“CellRecommendedMax”/> |
| 78. | <attribute type=“CellList”/> |
| 79. | <attribute type=“CellAssociatedItem”/> |
| 80. | <attribute type=“CellHidden”/> |
| 81. | <element type=“CellPropertyLink” minOccurs=“0” |
| | maxOccurs=“1”/> |
| 82. | <element type=“CellCalculationLink” minOccurs=“0” |
| | maxOccurs=“1”/> |
| 83. | <element type=“Table” minOccurs=“0” maxOccurs=“1”/> |
| 84. | <element type=“CellBitFieldList” minOccurs=“0” |
| | maxOccurs=“1”/> |
| 85. | <element type=“CellMultipleEntryList” minOccurs=“0” |
| | maxOccurs=“1”/> |
| 86. | <element type=“ScriptRules” minOccurs=“0” |
| | maxOccurs=“1”/> |

| | |
|---|---|
| 87. | </ElementType> |
| 88. | <ElementType name=“TableCells”> |

| | |
|---|---|
| 89. | <element type=“TableCell” minOccurs=“0” |
| | maxOccurs=“*”/> |

| | |
|---|---|
| 90. | </ElementType> |
| 91. | <ElementType name=“Table”> |

| | |
|---|---|
| 92. | <attribute type=“TableName”/> |
| 93. | <attribute type=“TableFixedLength”/> |
| 94. | <attribute type=“TableNumberOfRecords”/> |
| 95. | <attribute type=“TableMemoryDestination”/> |
| 96. | <attribute type=“TableRecordType”/> |
| 97. | <attribute type=“TableReadOnly”/> |
| 98. | <attribute type=“MakeChecksum”/> |
| 99. | <element type=“ScriptRules” minOccurs=“0” |
| | maxOccurs=“1”/> |
| 100. | <element type=“TableCells” minOccurs=“0” |
| | maxOccurs=“1”/> |

| | |
|---|---|
| 101. | </ElementType> |
| 102. | <ElementType name=“Tables”> |

| | |
|---|---|
| 103. | <element type=“Table” minOccurs=“0” maxOccurs“*”/> |

| | |
|---|---|
| 104. | </ElementType> |
| 105. | <ElementType name=“Application”> |

| | |
|---|---|
| 106. | <element type=“Tables” minOccurs=“1” maxOccurs=“1”/> |
| 107. | <element type=“ScriptRules” minOccurs=“0” |
| | maxOccurs=“1”/> |

| | |
|---|---|
| 108. | </ElementType> |

Table 2 illustrates an example script function element in a configuration definition. The name of the script function is “NumberOfMeter” and returns a value of type “long.” This example function calculates the number of meters needed in a device that monitors potential and current for substation monitoring. The number of meters is derived from the number of potential transformers (“Pts”) and current transfers of the device (“Cts”). The script function has 2 parameters: “NumberOfPts” and “NumberOfCts.” The values for the parameters are calculated by invoking a script function named “NumberOfPts” and “NumberOfCts” as indicated by the script parameters type of “calculation.” These script functions are defined within the script rules element directly below the application element. To determine the value for a cell, the configuration system invokes each of the script functions to calculate the parameter values, and then invokes the “NumberOfMeters” script function passing the parameter values. The script functions are stored in the configuration scripts file.

TABLE 2
<ScriptFunction ScriptFunctionName=“NumberOfMeters”
ScriptFunctionReturnType=“long”>

<ScriptParameters>

<ScriptParameter ScriptParameterNumber=“1”

ScriptParameterName=“NumberOfPts” ScriptParameterDataType=“long”
ScriptParameterType=“Calculation” ScriptParameterCalculationName=
“NumberOfPts”/>

<ScriptParameter ScriptParameterNumber=“2”

ScriptParameterName=“NumberOfCts” ScriptParameterDataType=“long”
ScriptParameterType=“Calculation” ScriptParameterCalculationName=
“NumberOfCts”/>

</ScriptParameters>

</ScriptFunction>

Table 3 illustrates a portion of the script functions file. This portion defines the script function named “NumberOfMeters.”

TABLE 3

Function NumberOfMeters(NumberOfPts, NumberOfCts)
NumberOfMeters = 0

Select Case NumberOfPts

Case 0:

Select Case NumberOfCts

Case 0:

NumberOfMeters = 0

End Select

Case 3:

Select Case NumberOfCts

Case 0:

NumberOfMeters = 0

Case 3:

NumberOfMeters = 1

Case 6:

NumberOfMeters = 2

Case 9:

NumberOfMeters = 3

Case 12:

NumberOfMeters = 4

End Select

Case 6:

Select Case NumberOfCts

Case 0:

NumberOfMeters = 0

Case 3:

NumberOfMeters = 2

Case 6:

NumberOfMeters = 3

Case 9:

NumberOfMeters = 3

End Select

End Select

End Function

Table 4 illustrates a table element. This table element defines a table with 120 records. Each record contains a cell named “ReportEnabled” and a cell named “Report Limit.” The value of the “ReportEnabled” cell is calculated by invoking the “ReportEnabled” script function passing the value of the “NumberOfMeters” and the “RecordNumber.” The value of the “ReportLimit” cell is 32, as indicated by the cell default value.

TABLE 4
<Table TableName=“AC Accumulator Reporting” TableFixedLength=“0” TableNumberOfRecords=“120”
TableMemoryDestination=“NVRAM” TableRecordType=“MultipleElement”>
<TableCells>

<TableCell CellName=“ReportEnabled” CellType=“ubyte” CellDefaultValue=“0” CellMax=“1”

CellMin=“0”>

<ScriptRules>

<ScriptRule ScriptRuleSequence=“1”>

<ScriptFunctions>

<ScriptFunction ScriptFunctionName=“ReportEnabled” ScriptFunctionReturnType=“long”

ScriptFunctionSequence=“1”>

<ScriptParameters>

<ScriptParameter ScriptParameterNumber=“1” ScriptParameterName=“NumberOfMeters”

ScriptParameterDataType=“long” ScriptParameterType=“Calculation”
ScriptParameterCalculationName=“NumberOfMeters”/>

<ScriptParameter ScriptParameterNumber=“2” ScriptParameterName=“RecordNumber”

ScriptParameterDataType=“long” ScriptParameterType=“Code”/>

</ScriptParameters>

</ScriptFunction>

</ScriptFunctions>

</ScriptRule>

</ScriptRules>

</TableCell>
<TableCell CellName=“Report Limit” CellType=“ubyte” CellDefaultValue=“32” CellMax=“255”

CellMin=“0”/>
</TableCells>
</Table>

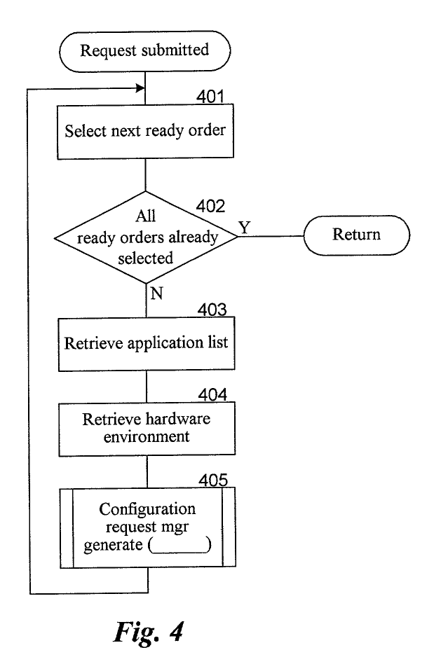

FIG. 4 is a flow diagram illustrating the processing of the request submitter component in one embodiment. The component loops, selecting each order from the order database that is ready to be processed and invokes the configuration request manager component to generate the configured applications for the selected order. Alternatively, the request submitter may be event driven in that the request submitter is started and provided with order information for a single order when that order is submitted (i.e., an order event). In block 401, the component selects the next ready order from the order database. In decision block 402, if all the ready orders have already been selected, then the component returns, else the component continues at block 403. In block 403, the component retrieves the list of applications from the selected order. In block 404, the component retrieves the hardware environment from the selected order. In block 405, the component invokes the generate function of the configuration request manager component passing of the application list, the hardware environment, and the order identifier. The component then loops to block 401 to select the next ready order.

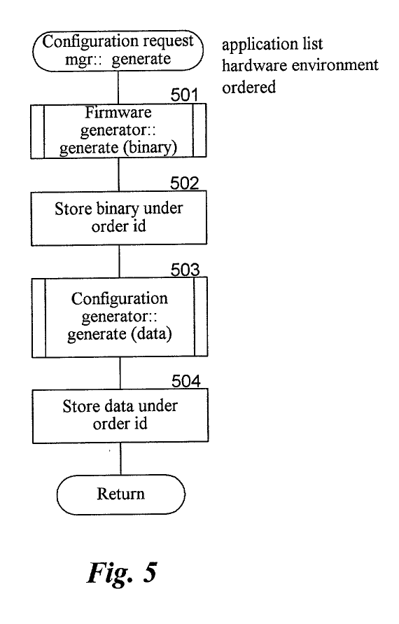

FIG. 5 is a flow diagram illustrating the processing of the configuration request manager component in one embodiment. The component is passed an application list, a hardware environment, and an order identifier. The component generates the binary code for the applications in the list, generates the configuration data for the applications, and stores the binary code and configuration data in the configuration repository in association with the order identifier. In block 501, the component invokes the generate function of the firmware generator component, passing the application list and receiving the binary code in return. In block 502, the component stores the binary code in the configuration repository in association with the order identifier. In block 503, the component invokes the generate function of the configuration generator component, passing the application list and hardware environment and receiving configuration data in return. In block 504, the component stores the configuration data in the configuration repository in association with the order identifier. The component then returns.

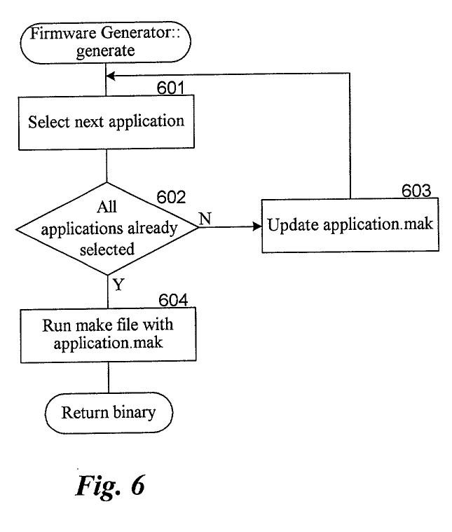

FIG. 6 is a flow diagram illustrating the processing of the generate function of the firmware generate component in one embodiment. The component is passed an application list and returns the binary code for those applications. The component may also be passed the hardware environment to further refine the generation of the binary code. In blocks 601-603, the component loops, creating an application makefile that has an entry for each application. In block 601, the component selects the next application. In decision block 602, if all the applications have already been selected, then the component continues at 604, else the component continues at block 603. In block 603, the component updates the application makefile and then loops to block 601 to select the next application. In block 604, the component invokes the makefile program passing the application makefile. The makefile program generates the binary code for the applications as specified by the application makefile. The component then returns the binary code.

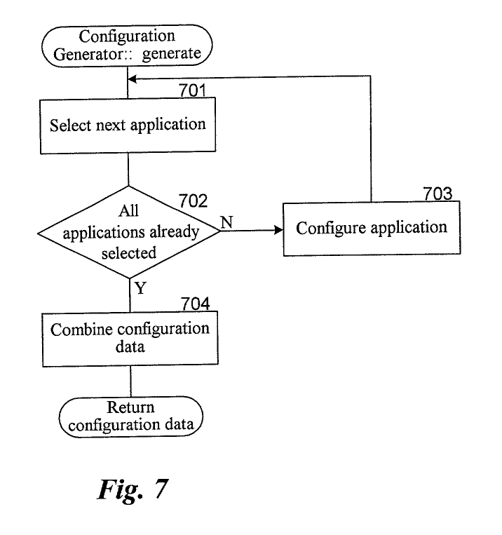

FIG. 7 is a flow diagram illustrating the processing of the generate function of the configuration generator component in one embodiment. The component is passed an application list and a hardware environment, and returns the configuration data for those applications within the hardware environment. In blocks 701-703, the component loops, selecting each application and generating the configuration data for the application. In block 701, the component selects the next application. In decision block 702, if all the applications have already been selected, then the component continues at block 704, else the component continues at block 703. In block 703, the component invokes the configure application component to generate the configuration data for the selected application and then loops to block 701 to select the next application. In block 704, the component combines the configuration data for the applications and then returns the combined configuration data.

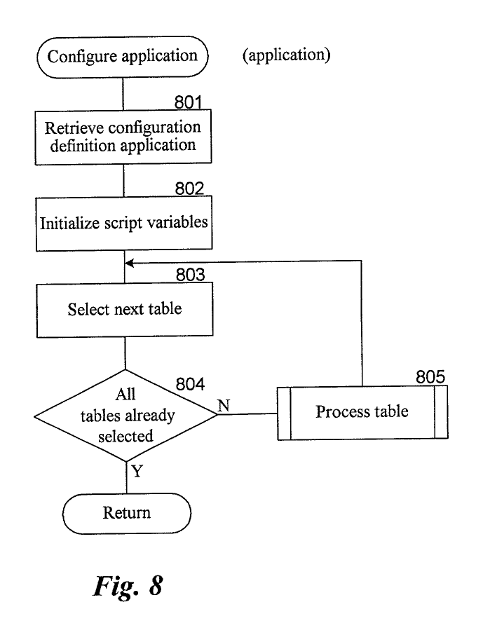

FIG. 8 is a flow diagram illustrating the processing of the configure application component in one embodiment. The component is passed an indication of an application, retrieves the configuration definition for that application, processes each table specified in the configuration definition, and returns the configuration data. In block 801, the component retrieves the configuration definition for the passed application. In block 802, the component initializes script variables based on the hardware environment. In blocks 803-805, the component loops, processing each table in the configuration definition. In block 803, the component selects the next table in the configuration definition. In decision block 804, if all the tables of the configuration definition have already been selected, then the component returns, else the component continues at block 805. In block 805, the component invokes the process table component to generate the configuration data for the selected table. The component then loops to block 803 to select the next table.

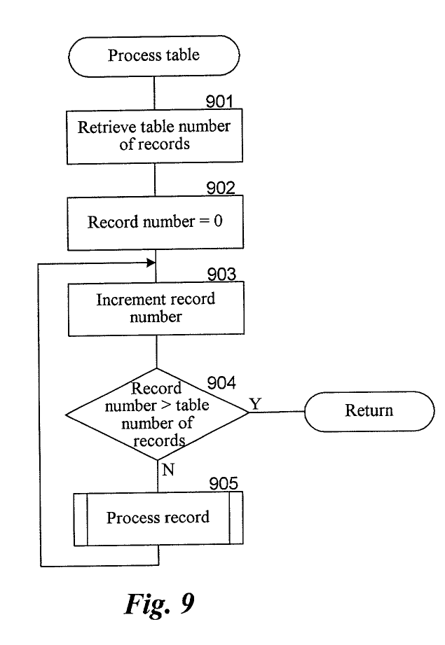

FIG. 9 is a flow diagram illustrating the processing of the process table component in one embodiment. The component is passed an indication of the table definition and populates the cells of the records of the table. In block 901, the component retrieves the number of records from the table definition. In block 902, the component sets a record number variable to 0. The scripts may use of the record number when generating the data for a cell of the record. In blocks 903-905, the component loops, generating each record of the table. In block 903, the component increments of the record number variable. In decision block 904, if the record number is greater than the number of records in the table, then the component returns, else the component continues at block 905. In block 905, the component invokes the process record component and then loops to block 903 to process the next record.

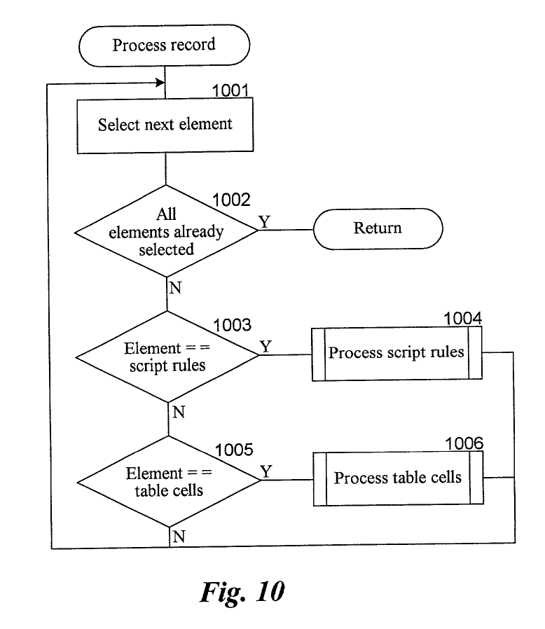

FIG. 10 is a flow diagram illustrating the processing of the process record component in one embodiment. The component is passed an indication of a record and populates the cells of the record. In block 1001, the component selects the next element of the table definition. In decision block 1002, if all the elements have already been selected, then the component returns, else the component continues at block 1003. In decision block 1003, if the element is a script rules element, then the component continues at block 1004, else the component continues at block 1005. In block 1004, the component invokes the process script rules component and then loops to block 1001 to select the next element. In decision block 1005, if the selected element is a table cells element, then the component continues at block 1006. In block 1006, the component invokes the process table cells component. The component then loops to block 1001 to select the next element of the table definition.

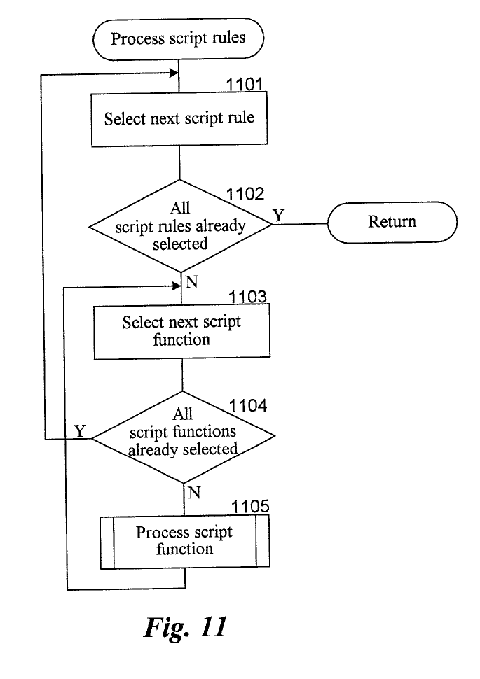

FIG. 11 is a flow diagram illustrating the processing of the process script rules component in one embodiment. The component processes each script function within each script rule. In block 1101, the component selects the next script rule of the script rules element. In decision block 1102, if all the script rules have already been selected, then the component returns, else component continues at block 1103. In blocks 1103-1105, the component loops, processing each script function of the selected script rule. In block 1103, the component selects the next script function of the selected script rule. In decision block 1104, if all the script functions of the selected script rule have already been selected, then the component loops to block 1101 to select the next script rule, else the component continues at block 1105. In block 1105, the component invokes the process script function for the selected script function and then loops to block 1103 to select the next script function.

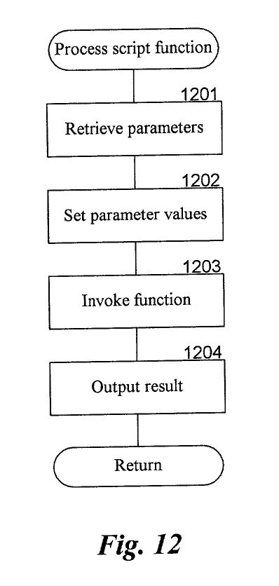

FIG. 12 is a flow diagram illustrating the processing of the process script function component in one embodiment. The component is passed an indication of the script function, sets the parameter values for the script function, invokes the script function, and stores the results. In block 1201, the component retrieves the parameters for the script function. In block 1202, the component sets the parameter values for the script function. In block 1203, the component invokes the script function. In block 1204, the component outputs the result of the script function. The result may be output to the next location within a global table data structure for holding the configuration data.

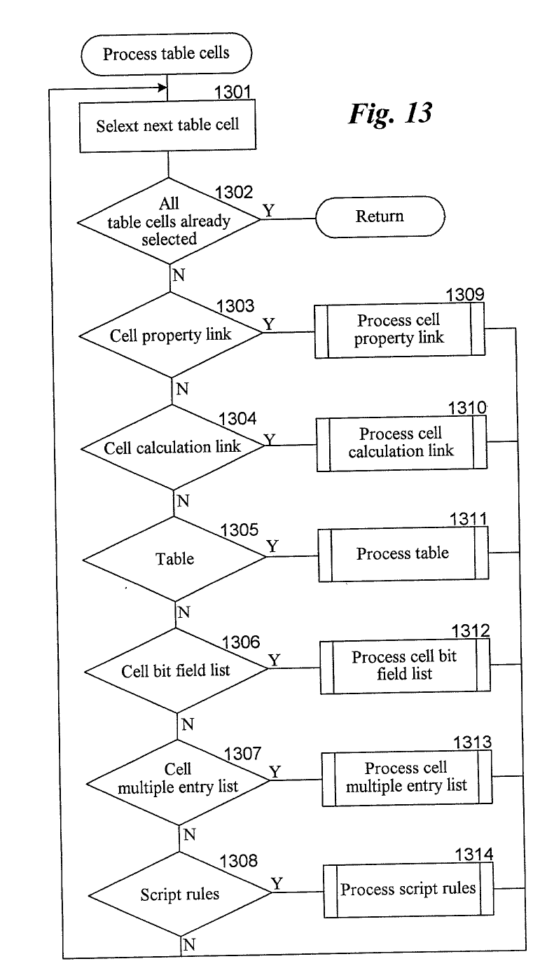

FIG. 13 is a flow diagram illustrating the processing of the process table cells component in one embodiment. In blocks 1301-1314, the component loops processing each table cell. In block 1301, the component selects the next table cell. In decision block 1302, if all the table cells have already been selected, then the component returns, else the component continues at block 1303. In blocks 1303-1314, the component identifies the type of the selected table cell and invokes the corresponding processing routine. For example, in decision block 1303, if the selected table cell is a cell property link, then the component invokes the process cell property link component and then loops to block 1301 to select the next table cell.

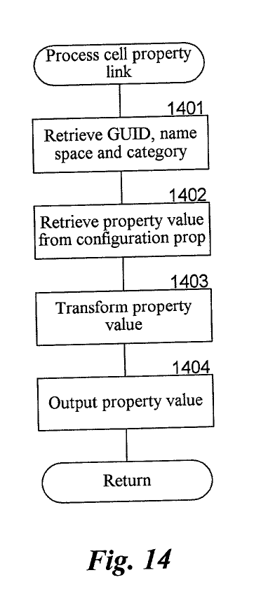

FIG. 14 is a flow diagram illustrating the processing of the process cell property link component in one embodiment. This component sets the value of a cell to a value retrieved from the configuration properties file. In block 1401, the component retrieves the globally unique identifier for the property, the namespace, and category from the element. The globally unique identifier may uniquely identify a value pair within the namespace and category. In block 1402, the component retrieves the value of the property from the configuration properties file. In block 1403, the component transforms the property value in accordance with any transform specified in the element. For example, the transforming may transform a date in MM/DD/YY format to DD/MM/YY format. In block 1404, the component outputs the transform property value and then returns.

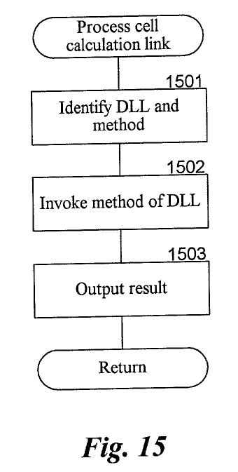

FIG. 15 is a flow diagram illustrating the processing of the process cell calculation link component in one embodiment. The component sets the value of a cell to the value returned by invoking a function of the specified DLL. In block 1501, the component identifies the DLL and function from the element. In block 1502, the component invokes the function of the DLL. In block 1503, the component outputs the returned result and then returns.

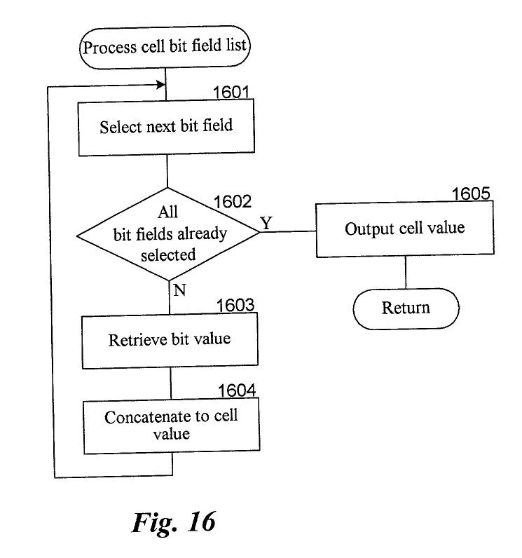

FIG. 16 is a flow diagram illustrating the processing of the process cell bit field list component in one embodiment. In block 1601, the component selects the next bit field specified by the element. In block 1602, if all the bit fields have already been selected, then the component continues at block 1605, else the component continues at block 1603. In block 1603, the component retrieves the bit value from the element. In block 1604, the component concatenates the retrieved bit value to the cell value, and then loops to block 1601 to select the next bit field. In block 1605, the component outputs the concatenated cell value and then returns.

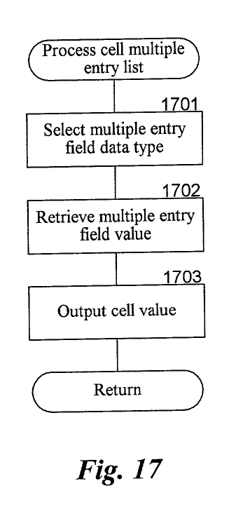

FIG. 17 is a flow diagram illustrating the processing of the cell multiple entry list component in one embodiment. In block 1701, the component selects the data type of the multiple entry cell. In block 1702, the component retrieves the multiple entry field value. In block 1703, the component outputs the value and returns.

From the above description, it will be appreciated that through the specific embodiments of the configuration system that have been described for purposes of illustration, various modifications may be made without deviating from the scope of the invention. Accordingly, the invention is not limited, except by the following claims.

1. A method in a computer system for generating a set of configured applications for a device, the method comprising:
providing an indication of a plurality of applications;
providing an indication of a hardware environment of the device;
for each application of the plurality of applications,
identifying binary code for the application;
retrieving a configuration definition for the application, the configuration definition defining configuration data for configuring the application when the application is used in various hardware environments; and
generating from the retrieved configuration definition configuration data for the application executing in the provided hardware environment; and
combining the identified binary code and generated configuration data to form the set of configured applications.

2. The method of claim 1 wherein the configuration definition defines a table of configuration values.

3. The method of claim 2 wherein the table contains a plurality of records with cells and the configuration definition specifies the value for each cell of each record.

4. The method of claim 3 wherein the value of a cell is calculated by invoking a script specified in the configuration definition.

5. The method of claim 3 wherein the value of a cell is calculated by invoking a function of a library specified in the configuration definition.

6. The method of claim 1 including setting global variables based on the provided hardware environment and wherein the global variables are used when generating the configuration data for each application.

7. The method of claim 1 including providing a property file that maps property identifiers to values and wherein the generating of the configuration data includes retrieving the value from the property file based on a property identifier specified in the configuration definition.

8. A computer-based method for ordering devices via the Internet, the method comprising:
providing one or more display pages through which a customer can place an order for a device, the order specifying a hardware environment of the device and specifying one or more applications to be delivered with the device;
receiving through the provided display pages an indication that an order has been placed; and
automatically generating configuration data for the one or more applications specified in the received order, the configuration data being generated based on the hardware environment specified in the received order.

9. The method of claim 8 wherein the automatically generating of the configuration data generates the configuration data based on a configuration definition for each application, the configuration definition defining configuration data for configuring an application when the application is used in various hardware environments.

10. The method of claim 9 wherein the configuration definition defines a table of configuration values.

11. The method of claim 10 wherein the table contains a plurality of records with cells and the configuration definition specifies the value for each cell of each record.

12. The method of claim 11 wherein the value of a cell is calculated by invoking a script specified in the configuration definition.

13. The method of claim 11 wherein the value of a cell is calculated by invoking a function of a library specified in the configuration definition.

14. The method of claim 9 including wherein the automatically generating includes setting global variables based on the specified hardware environment and wherein the global variables are used when generating the configuration data for each application.

15. The method of claim 9 including providing a property file that maps property identifiers to values and wherein the generating of the configuration data includes retrieving the value from the property file based on a property identifier specified in the configuration definition.

16. The method of claim 8 including identifying binary code for each application specified in the received order.

17. The method of claim 16 including combining the identified binary code with configuration data to form a configured application.

18. The method of claim 16 wherein the identifying of binary code includes compiling binary code from source code after the order is placed.

19. The method of claim 8 including before an order is placed, ensuring that the order specifies a hardware environment with a combination of hardware that is compatible.

20. The method of claim 8 including before an order is placed, ensuring that the order specifies a combination of applications that is compatible.

21. The method of claim 8 including before an order is placed, ensuring that the order specifies applications that are compatible with the specified hardware environment.

22. A method for automatically generating a set of configured applications for a specified set of applications within a specified hardware environment, the method comprising:
receiving a specification of applications;
receiving a specification of a hardware environment;
generating executable application code for the specified applications;
generating configuration data for the specified applications based on the specified hardware environment; and
storing the generated executable application code and the generated configuration data in memory of the device.

23. The method of claim 22 wherein the specification of the applications and the specification of the hardware environment are received when a user places an order for a device that is to have the specified hardware environment and the applications.

24. The method of claim 23 wherein the order is placed via the Internet.

25. The method of claim 22 wherein the configuration data is generated based on a configuration definition.

26. The method of claim 25 wherein the configuration definition defines a table of configuration values.

27. The method of claim 26 wherein the table contains a plurality of records with cells and the configuration definition specifies the value for each cell of each record.

28. The method of claim 27 wherein the value of a cell is calculated by invoking a script specified in the configuration definition.

29. The method of claim 27 wherein the value of a cell is calculated by invoking a function of a library specified in the configuration definition.

30. The method of claim 25 including providing a property file that maps property identifiers to values and wherein the generating of the configuration data includes retrieving the value from the property file based on a property identifier specified in the configuration definition.

31. The method of claim 22 including setting global variables based on the specified hardware environment and wherein the global variables are used when generating the configuration data for the applications.

32. A computer-readable medium containing a data structure providing a configuration definition for an application, comprising:
for each of a plurality of tables,
a definition of a table that includes
an indication of a number of records in the table; and
an indication of how to populate a cell of a record wherein the indication of how to populate specifies a function to be invoked to generate the value for populating the cell.

33. The computer-readable medium of claim 32 wherein the indication of how to populate a cell specifies a value for populating the cell.

34. The computer-readable medium of claim 32 wherein the indication of how to populate a cell specifies a script of the configuration definition to be invoked to generate the value for populating the cell.

35. The computer-readable medium of claim 32 wherein the configuration definition includes an indication of parameters to be passed to an invoked function.

36. The computer-readable medium of claim 32 wherein the indication of how to populate a cell specifies a property of a property file and the value associated with the property is the value for populating the cell.

37. A computer system for generating a set of configured applications for a device, comprising:
a component that identifies binary code for applications to be included with the device;
a data store with a configuration definition for applications, the configuration definition defining configuration data for configuring an application when the application is used in various hardware environments; and
a generation component that generates configuration data for applications based on the configuration definition in the data store in accordance with a specified hardware environment
wherein the identified binary code and generated configuration data form the set of configured applications.

38. The computer system of claim 37 wherein the configuration definition defines a table of configuration values.

39. The computer system of claim 38 wherein the table contains a plurality of records with cells and the configuration definition specifies the value for each cell of each record.

40. The computer system of claim 39 wherein the value of a cell is calculated by invoking a script specified in the configuration definition.

41. The computer system of claim 39 wherein the value of a cell is calculated by invoking a function of a library specified in the configuration definition.

42. The computer system of claim 37 including a property file that maps property identifiers to values and wherein the generation component retrieves the value from the property file based on a property identifier specified in the configuration definition.

43. A computer-readable medium containing instructions for controlling a computer system to generate configured applications in accordance with a hardware environment and applications specified in an order, by a method comprising:
providing via the Internet a display page for placing an order for a device, the order specifying a hardware environment of the device and specifying an application for the device;
receiving through the provided display page an indication that a customer has placed an order; and
automatically generating configuration data for the application specified in the received order, the configuration data being generated based on the hardware environment specified in the received order.

44. The computer-readable medium of claim 43 wherein the automatically generating of the configuration data generates the configuration data based on a configuration definition for the application, the configuration definition defining configuration data for configuring the application when the application is used in various hardware environments.

45. The computer-readable medium of claim 44 wherein the configuration definition defines a table of configuration values.

46. The computer-readable medium of claim 45 wherein the table contains a plurality of records with cells and the configuration definition specifies the value for each cell of each record.

47. The computer-readable medium of claim 46 wherein the value of a cell is calculated by invoking a script specified in the configuration definition.

48. The computer-readable medium of claim 46 wherein the value of a cell is calculated by invoking a function of a library specified in the configuration definition.

49. The computer-readable medium of claim 44 including providing a property file that maps property identifiers to values and wherein the generating of the configuration data includes retrieving the value from the property file based on a property identifier specified in the configuration definition.

50. The computer-readable medium of claim 43 including identifying binary code for each application specified in the received order.

51. The computer-readable medium of claim 50 including combining the identified binary code with the configuration data to form a configured application.

52. The computer-readable medium of claim 50 wherein the identifying binary code includes compiling binary code from source code after the order is received.

53. A computer system for generating configured applications for a device, comprising:
means for identifying binary code for applications to be included with the device;
means for storing configuration definitions for applications, the configuration definition defining configuration data for configuring an application when the application is used in various hardware environments; and
means for generating configuration data for applications based on the configuration definition in the data store in accordance with a specified hardware environment.

54. The computer system of claim 53 wherein the configuration definition defines a table of configuration values.

55. The computer system of claim 54 wherein the table contains a plurality of records with cells and the configuration definition specifies the value for each cell of each record.

56. The computer system of claim 55 wherein the value of a cell is calculated by invoking a script specified in the configuration definition.

57. The computer system of claim 55 wherein the value of a cell is calculated by invoking a function of a library specified in the configuration definition.

58. The computer system of claim 53 including a property file that maps property identifiers to values and wherein the means for generating the configuration data includes means for retrieving the value from the property file based on a property identifier specified in the configuration definition.

59. A method in a client computer for ordering devices via the Internet, the method comprising:
receiving a web page through which an order for a device can be placed, the order specifying a hardware environment of the device and specifying an application to be delivered with the device; and
upon receiving a specification of an order from a customer, submitting the order to a server computer through the provided display pages
wherein configuration data is automatically generated for the application specified in the received order, the configuration data being generated based on the hardware environment specified in the received order and wherein the application and configuration data is loaded into the device.

60. The method of claim 59 wherein the order is submitted to a web server computer that directs a configuration server computer to generate the configuration data in accordance with the submitted order.
